(19) United States
(12) Patent Application Publication
(10) Pub. No.: US 2025/0136165 A1
(43) Pub. Date: May 1, 2025

(54) COLLAPSIBLE INFANT CARRIAGE

(71) Applicant: Mark Andrew FRASER, Queensland (AU)

(72) Inventor: Mark Andrew FRASER, Queensland (AU)

(21) Appl. No.: 18/683,210

(22) PCT Filed: Aug. 12, 2022
(86) PCT No.: PCT/AU2022/050886

§ 371 Date: Feb. 12, 2024

(30) Foreign Application Priority Data
Aug. 13, 2021 (AU) 2021105445
Aug. 13, 2021 (AU) 2021215278

(51) Int. Cl. B62B 7/12

(52) U.S. Cl. CPC B62B 7/12; B62B 2301/05

(57) ABSTRACT

The present invention relates to a collapsible infant carriage including a pair of shells for collapsing together. Advantageously, the infant carriage may be converted into a wheeled suitcase for straightforward and safe transport. Preferably, the carriage further includes a fastener for fastening the collapsed shells together so that the interior is protected from dirt and/or weather.

### TECHNICAL FIELD

The present invention relates to a collapsible infant carriage, such as a pram or stroller.

### BACKGROUND

The reference to any prior art in this specification is not, and should not be taken as an acknowledgement or any form of suggestion that the prior art forms part of the common general knowledge.

Prams and strollers are used to safely transport babies. Typically, such infant carriages have capsules, bassinets or seats attached to a frame.

Although infant carriages can be collapsed and folded for transport on public transport, planes, etc, they are often cumbersome to handle and prone to breakage. The preferred embodiment provides an infant carriage for improved transport.

Further, the exposed carriage fabric often undesirably becomes dirty or sodden in the rain. The preferred embodiment provides an infant carriage that is protected from dirt and/or weather.

Although infant carriages have storage compartments, such compartments are often difficult to access when the carriage is collapsed. The preferred embodiment provides an infant carriage with a readily accessible storage compartment when collapsed.

### SUMMARY OF THE INVENTION

According to one aspect of the present invention, there is provided a collapsible infant carriage including a pair of shells for collapsing together.

The carriage may be convertible into a suitcase for straightforward and safe transport. The suitcase may be a wheeled suitcase.

The shells may be pivotally fastened together. The uncollapsed shells may include an upper shell and a lower shell. Each shell may be formed form durable and hard material which resists breakage, preferably plastics material. Each shell may be molded, preferably injection molded. Each shell may have an arcuate major face.

The infant carriage may include at least one handle extending from at least one of the shells. The infant carriage may include a pair of handles extending from respective shells. Each handle may be opposed. Each handle may be retractable, preferably axially retractable. Each handle may be height-adjustable.

The carriage may include a rear wheel mount to which one or more rear wheels are fastened. The wheel mount may be pivotally mounted to the shells. The shells and wheel mount may include a common hinge. The wheel mount may be cantilevered and/or extend obliquely. The rear wheels may be releasable. The mount may receive the collapsed shells. The rear wheels may be stored in the collapsed shells

The carriage may include one or more front wheels. The front wheels may be pivotally mounted to a lower one of the shells. The front wheels may be releasable. The front wheels may be stored in the collapsed shells.

The carriage may include a retractable canopy shelter. The retractable roof shelter may retract into an upper one of the shells. The retractable canopy shelter may include nesting or concertinaed segments. The carriage may include a pair of side shelters. Each shelter may retract into the shells. Each shelter may include one or more pivoting frames supporting flaccid sheet material. The carriage may include a restraint for restrain the pivoting of the shells beyond a maximum limit.

The carriage may further include a storage compartment for extending from a lower one of the shells. The storage compartment may be readily accessed when the shells are collapsed. The storage compartment may be retractable. The compartment may extend rearwardly when the shells are uncollapsed. The compartment may be under the carriage. The compartment may include a pivotable panel, and a pair of flanks extending from the panel. The panel may be hard and durable. The flanks may be formed from flaccid sheet material.

The carriage may further include a reclining backrest for extending from an upper one of the shells. The backrest may be retractable. The backrest may extend rearwardly when the shells are uncollapsed. The backrest may include a pivotable panel, and a pair of flanks extending from the panel. The panel may be hard and durable. The flanks may be formed from flaccid sheet material.

The carriage may further include a fastener for fastening the collapsed shells together so that the interior is protected from dirt and/or weather. The fastener may include a zip extending along a perimeter of the shells and/or a clip for clipping free ends of the shells.

The carriage may include a seat. The seat may be pivotally mounted to the shells. The carriage may include a footrest. The seat and footrest may include flaccid sheet material.

According to another aspect of the present invention, there is provided a method for collapsing an infant carriage, the method including collapsing a pair of shells together.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1A shows a side view of a collapsible infant carriage in accordance with an embodiment of the present invention; and

FIGS. 2B-G show the steps in collapsing the infant carriage of FIG. 1A.

### DETAILED DESCRIPTION OF PREFERRED EMBODIMENTS

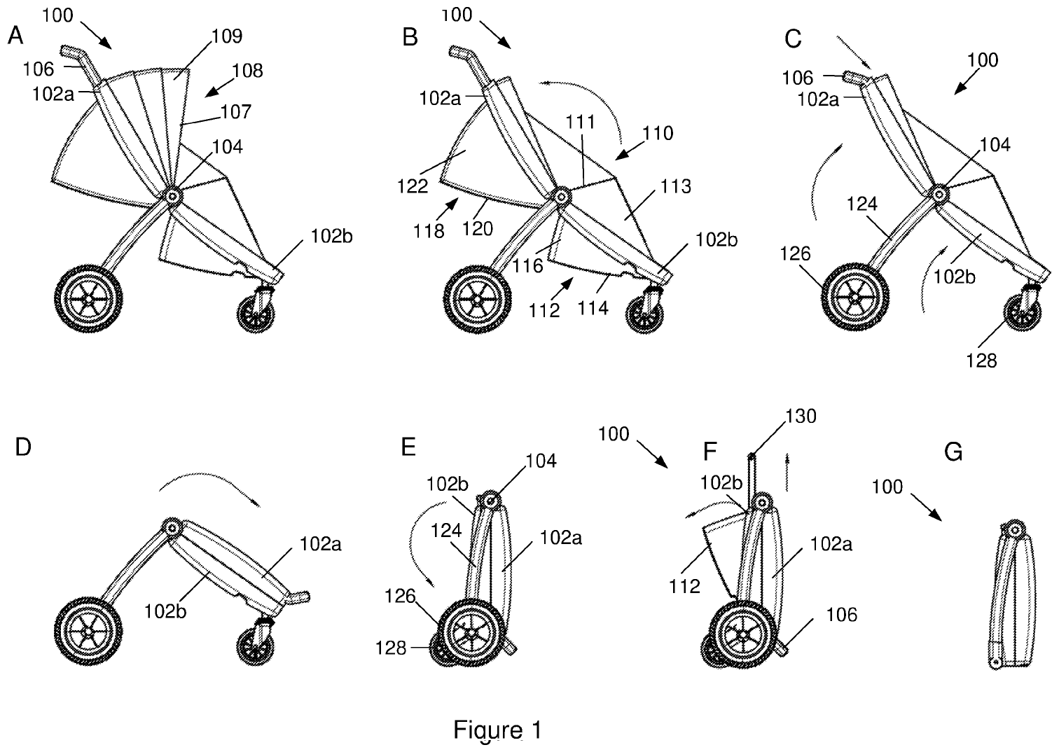

According to an embodiment of the present invention, there is provided a collapsible infant carriage 100 as shown in FIG. 1A. The carriage 100 includes a pair of hinged shells 102a, 102b for collapsing together. A fastener is provided for fastening the collapsed shells 102a, 102b together so that the interior is protected from dirt and/or weather. The fastener includes a zip extending along a perimeter of the shells 102a, 102b and/or a clip for clipping together free ends of the shells 102a, 102b.

Advantageously, the carriage 100 is convertible into a hard shell suitcase as shown in FIGS. 1F and 1G for straightforward and safe transport. The suitcase may be a wheeled suitcase as shown in FIG. 1F.

Returning to FIG. 1A, the shells 102a, 102b are pivotally fastened together using a hinge 104 so that the interior can be protected from dirt and weather when collapsed. The uncollapsed shells include an upper shell 102a and a lower shell 102b. Each shell 102 is formed form durable and hard material which resists breakage, preferably plastics material. Each shell 102 is molded, and preferably injection molded. Each shell 102 is similarly shaped, with an arcuate major face to maximise internal storage and provide strength.

The carriage 100 includes a heavy-duty carriage handle 106 extending from the upper shell 102a. The height-adjustable handle 106 is axially retractable into the shell 102a. The carriage 100 also includes a canopy shelter 108, with nesting or concertinaed segments, that retracts into the upper shell 102a. The sun shelter 108 includes hoop frames 107, pivoting about hinge 104 and supporting flaccid sheet material 109, preferably fabric.

Turning to FIG. 1B, the carriage 100 also includes a pair of spaced apart wind shelters 110, between which an infant is located and fastened to the shells 102a 102b. The side shelters 110 also include one or more straight frames 111, pivoting about hinge 104 and supporting flaccid sheet material 113, and retracting or folding into the shells 102a 102b. The side shelters 110 also restrain the open pivoting of the shells 102a 102b to a maximum limit.

The carriage 100 further includes an underside storage compartment 112 for extending from the lower shell 102b. The storage compartment 112 includes a pivotable panel 114, and a pair of spaced flanks 116 extending from the panel 114. The panel 114 is hard and durable plastic, and may or may not form part of the lower shell 102b. The tapered flanks 116 are formed from flaccid sheet material, preferably fabric. Advantageously, the storage compartment 112 is also readily accessible when the shells 102a 102b are collapsed to form a suitcase (FIG. 1F).

The carriage 100 further includes a reclining infant backrest 118 for pivotally extending from the surrounding remainder of the upper shell 102a. The backrest 118 is retractable and extends rearwardly when the shells 102a 102b are uncollapsed. The backrest 118 includes a pivoting panel 120, and a pair of spaced flanks 122 extending from the panel 120. The panel 120 is hard and durable plastic, forming part of the upper shell 102a. The tapered flanks 122 are formed from flaccid sheet material, preferably fabric.

The carriage 100 also includes an internal seat (not shown) pivotally mounted to the shells 102a 102b between the ribs 111, and an internal footrest in the lower shell 102b. In one embodiment, the seat and footrest can be formed from flaccid sheet material, preferably fabric.

Turning to FIG. 1C, the carriage 100 includes a rear wheel mount 124 to which two larger rear wheels 126 are fastened. The wheel mount 124 is pivotally mounted to the shells 102a 102b about the hinge 104. The cantilevered wheel mount 124 extends obliquely from the shells 102a 102b, and can be retracted so that legs receive the collapsed shells 102a, 102b (FIG. 1E).

The carriage 100 also includes two smaller front wheels 128. The front wheels 128 are pivotally mounted to the lower shell 102b. The front wheels 128 can pivot through 360 degrees about a vertical axis as well as rotate about a horizontal axis, whereas the rear wheels 126 are confined to only rotating about a horizontal axis. Both the rear wheels 126 and front wheels 128 are readily releasable, and can be stored in the collapsed shells 102a, 102b for vehicular transport (FIG. 1G).

Turing to FIG. 1F, the carriage 100 also includes a suitcase handle 130 extending from the lower shell 102b. The height-adjustable handle 130 is axially retractable into the shell 102b, and need not support as much weight as the carriage handle 106. The handles 106, 130 are opposed.

A method for collapsing the infant carriage 100 is now described with reference to FIGS. 1A to 1G.

Initially in FIG. 1A, the infant carriage 100 is in an uncollapsed or erected configuration. The shells 102a 102b are open, all parts are fully extended, the fabric seat is substantially aligned with and extends between near horizontal frames 111.

In FIG. 1B, the canopy shelter 108 is retracted into the upper shell 102a.

In FIG. 1C, the carriage handle 106 is pushed into the upper shell 102a. The underside storage compartment 112 and backrest 118 are also retracted.

In FIG. 1D, the top shell 102a is pivoted toward the bottom shell 102b so that the shells 102a, 102b are collapsed together for fastening with a zipper or clip.

In FIG. 1E, the wheel mount 124 is pivotally retracted to receive the collapsed shells 102a, 102b. The resulting wheeled suitcase can stand upright.

In FIG. 1F, the suitcase handle 130 can be extended for wheeling around. The storage compartment 112 can conveniently still be opened and accessed for stowing or retrieving items.

In FIG. 1G, the wheels 126, 128 are removed and stored in the collapsed shells 102a, 102b, via either the storage compartment 112 which is then again retracted or through slightly pivoting the shells 102a, 102b apart before collapsing again and fastening. The collapsed carrier 100 is super compact for shipping and storage, with no exposed parts and therefore highly resistant to breakage.

A person skilled in the art will appreciate that many embodiments and variations can be made without departing from the ambit of the present invention.

In one embodiment, the canopy shelter 108 and/or side shelters 110 are releasable.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

The claims defining the invention are as follows:

1. A collapsible infant carriage including a pair of shells for collapsing together.

2. A collapsible infant carriage as claimed in claim 1, able to be converted into a suitcase for straightforward and safe transport, the suitcase optionally being a wheeled suitcase.

3. A collapsible infant carriage as claimed in claim 1, wherein the shells are pivotally fastened together, the uncollapsed shells including an upper shell and a lower shell.

4. A collapsible infant carriage as claimed in claim 1, wherein each shell:
is formed form durable and hard material which resists breakage, preferably plastics material.
is molded, preferably injection molded; and/or
each shell has an arcuate major face.

5. A collapsible infant carriage as claimed in claim 1, wherein the infant carriage includes at least one handle extending from at least one of the shells.

6. A collapsible infant carriage as claimed in claim 5, including a pair of handles opposed extending from respective shells, each handle being retractable and/or height-adjustable.

7. A collapsible infant carriage as claimed in claim 1, further including a rear wheel mount to which one or more rear wheels are fastened.

8. A collapsible infant carriage as claimed in claim 1, the wheel mount:
is pivotally mounted to the shells
extends obliquely from a hinge connecting the shells; and/or
receives the collapsed shells.

9. A collapsible infant carriage as claimed in claim 1, wherein the rear wheels are releasable and can be stored in the collapsed shells, and/or the carriage includes one or more releasable front wheels pivotally mounted to a lower one of the shells.

10. A collapsible infant carriage as claimed in claim 1, further including a retractable storage compartment for extending from a lower one of the shells, the storage compartment able to be readily accessed when the shells are collapsed.

11. A collapsible infant carriage as claimed in claim 10, wherein the storage compartment includes a pivotable panel, and a pair of flanks extending from the panel.

12. A collapsible infant carriage as claimed in claim 1, further including a retractable canopy shelter for retracting into an upper one of the shells, the retractable canopy shelter including nesting or concertinaed segments.

13. A collapsible infant carriage as claimed in claim 1, further including:
a pair of side shelters each including one or more pivoting frames supporting flaccid sheet material, and/or
a restraint for restraining the pivoting of the shells beyond a maximum limit.

14. A collapsible infant carriage as claimed in claim 1, wherein the carriage further includes a reclining backrest for extending from an upper one of the shells.

15. A collapsible infant carriage as claimed in claim 14, wherein the backrest is retractable and extends rearwardly when the shells are uncollapsed, the backrest including a pivotable panel, and a pair of flanks extending from the panel.

16. A collapsible infant carriage as claimed in claim 1, further including a fastener for fastening the collapsed shells together so that the interior is protected from dirt and/or weather.

17. A collapsible infant carriage as claimed in claim 16, wherein the fastener includes a zip extending along a perimeter of the shells and/or a clip for clipping free ends of the shells together.

18. A collapsible infant carriage as claimed in claim 1, wherein the carriage includes a seat which is pivotally mounted to the shells and/or a footrest.

19. A collapsible infant carriage as claimed in claim 18, wherein the seat and footrest may include flaccid sheet material.

20. A method for collapsing an infant carriage, the method including collapsing a pair of shells together.
